(19) United States
(12) Patent Application Publication
(10) Pub. No.: US 2025/0056611 A1
(43) Pub. Date: Feb. 13, 2025

(54) Sidelink Control Information (SCI) Signaling and Clear Channel Assessment (CCA) Methods for Sidelink Unlicensed (SL-U) Channel Occupancy Time (COT) Sharing and Resuming

(71) Applicant: Apple Inc., Cupertino, CA (US)

(72) Inventors: Huaning Niu, San Jose, CA (US); Chunxuan Ye, San Diego, CA (US); Wei Zeng, Saratoga, CA (US); Dan Wu, Beijing (CN); Dawei Zhang, Saratoga, CA (US); Ankit Bhamri, Haar (DE)

(21) Appl. No.: 18/793,454

(22) Filed: Aug. 2, 2024

(30) Foreign Application Priority Data
Aug. 9, 2023 (WO) PCT/CN2023/111953

(51) Int. Cl. H04W 74/0816; H04W 72/25; H04W 74/08

(52) U.S. Cl. CPC H04W 74/0816; H04W 72/25; H04W 74/0875

(57) ABSTRACT

Techniques for a wireless device to share a Channel Occupancy Time (COT) in a sidelink (SL) channel are disclosed. The techniques include a method for sharing a Channel Occupancy Time (COT) in a sidelink (SL) channel that includes performing a Clear Channel Assessment (CCA) by a first wireless device to initialize the COT. The first wireless device determines that a portion of the COT may be shared, and transmits to one or more qualifying wireless devices, first Sidelink Control Information (SCI). The first SCI may include a destination identification (ID), an offset, and a SL duration. The destination ID indicates one or more qualifying wireless devices that may share the COT, and the SL duration defines a duration of time available for the one or more qualifying wireless devices to share the COT. The first wireless device may resume transmission in the COT.

### CROSS REFERENCE TO RELATED APPLICATIONS

This application claims benefit to international application No. PCT/CN2023/111953, filed on Aug. 9, 2023, the contents of which are hereby incorporated by reference in its entirety.

### FIELD

The present application relates to wireless devices and wireless networks including devices, computer-readable media, and methods for enhancing sidelink communication in an unlicensed spectrum band.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

Aspects relate to devices, computer-readable media, and methods for enhancing sidelink communications. These aspects include a method for sharing a Channel Occupancy Time (COT) in a sidelink (SL) channel that includes performing a Clear Channel Assessment (CCA) by a first wireless device to initialize the COT. The first wireless device determines that a portion of the COT may be shared, and transmits to one or more qualifying wireless devices, first Sidelink Control Information (SCI). The first SCI may include a destination identification (ID), an offset, and a SL duration. The destination ID indicates one or more qualifying wireless devices that may share the COT, and the SL duration defines a duration of time available for the one or more qualifying wireless devices to share the COT. In some embodiments, the first wireless device may resume transmission in the COT.

In another aspect, embodiments relate to a communication devices, computer-readable media, and methods for sharing a COT in a sidelink SL channel. The method includes receiving, from a first wireless device, first Sidelink Control Information (SCI). The first SCI includes a destination ID, an offset, a SL duration and an indication of a Cyclic Prefix Extension (CPE) to be used. The destination ID indicates one or more qualifying wireless devices, and the SL duration defines a duration of time available for the one or more qualifying wireless devices to share the COT. The method includes determining the presence of an existing reservation for a non-qualifying wireless device in a slot in the SL duration, the existing reservation having a priority, and performing a Type 2 Clear Channel Assessment (CCA) and using the indicated CPE for a desired transmission during the SL duration. In embodiments, the CPE may be engineered to help facilitate the appropriate access to the resource.

In another aspect, embodiments relate to communication devices, computer-readable media, and methods for resource selection. The method includes a first wireless device receiving from a second wireless device first SCI. The first SCI includes a destination ID, an offset, a SL duration, a Maximum Channel Occupancy Time (MCOT) and a priority. The destination ID indicates one or more qualifying wireless devices, and the SL duration defines a duration of time available for the one or more qualifying wireless devices to share a portion of a COT. The method includes determining that the second wireless device is not one of the one or more qualifying wireless devices; determining that the priority is higher than a priority for a desired transmission from the second wireless device; and performing resource selection for the desired transmission that excludes the COT. The priority may be based on a Channel Access Priority Class (CAPC) value or L1 priority.

The techniques described herein may be implemented in and/or used with a number of different types of devices, including but not limited to cellular phones, wireless devices, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter can be obtained when the following detailed description of various aspects is considered in conjunction with the following drawings.

FIG. 1 illustrates an example wireless communication system, according to some aspects.

FIG. 2 illustrates an example block diagram of a UE, according to some aspects.

FIG. 3 illustrates a base station (BS) in communication with a user equipment (UE) device, according to some aspects.

FIGS. 4A and 4B illustrate different sidelink communications, according

to some aspects.

FIGS. 5A and 5B illustrate SCI signaling for sharing a COT, according

to some aspects.

FIGS. 6A and 6B illustrate SCI signaling for sharing portions of a COT, according to some aspects.

FIGS. 7A, 7B, and 7C illustrate different SCI signaling scenarios for sharing a COT, according to some aspects.

FIG. 8 illustrates sharing portions of a COT with non-responding communication devices, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In certain wireless communications systems, a wireless device may communicate directly with another wireless device without being routed through, for example, a wireless node. For example, a wireless device may establish a sidelink session with another peer wireless device. Once the sidelink session is established, the wireless device may monitor for messages from the other peer wireless device and vice versa.

Sidelink (SL) communication links are communication links established between terminals acting as UE devices. In SL communication, the physical channels may be associated with a set of resource elements carrying information originating from higher layers. These resource elements may be transmitted via sidelink physical signals used by a physical layer without carrying information originating from higher layers. These physical signals may include reference information signaling and the synchronization information signaling.

In accordance with embodiments, SL transmissions may be configured in accordance with a resource allocation pattern provided by the gNB. The resource allocation pattern may provide dynamic grants of sidelink resources, as well as grants of periodic sidelink resources configured semi-statically by sidelink configured grants. To improve a reliability of the SL transmissions, a dynamic sidelink grant DCI may provide resources for one or multiple transmissions of a transport block. The sidelink configured grants may be SL transmissions configured to be used by a UE device immediately, until these grants are released by RRC signaling.

In accordance with embodiments herein, the resource allocation patterns selected for the SL transmissions may be implemented in SL Bandwidth Parts (BWP). SL BWP may be sets of contiguous resource blocks configured for the SL transmissions inside a predetermined channel bandwidth. The configuration of the SL BWP and resource pools is established by the RRC layer and provided to lower layers when activated. There may be at least one active SL BWP for the UE device at a time in a given frequency band. The SL BWP may be defined by its frequency, bandwidth, Subcarrier Spacing (SCS), and Cyclic Prefix (CP). The SL BWP may define parameters common to all the resource pools that are contained within it, namely a number of symbols and starting symbol used for SL in all slots (except those with Synchronization Signal Block (SSB)), power control for PSBCH, and a location of a Direct Current (DC) subcarrier.

In 5G NR technologies, the resource pool located inside an SL BWP is defined by a set of contiguous Resource Blocks (RBs) defined by the information element labeled sl-Rb-Number in the frequency domain starting at an RB defined by the information element labeled sl-StartRBsubchannel. Further, the resource pool may be divided into subchannels of a size defined by the information element labeled sl-SubchannelSize, which can take one of multiple values (i.e., 10, 12, 15, 20, 25, 50, 75, and 100). Depending on the value of sl-RB-Number and sl-SubchannelSize, some RBs inside the resource pool may not be used by the UEs.

In the time domain, a resource pool has some available slots configured by various parameters. To determine which slots belong to the pool, a series of criteria is applied. For example, the slots where SSB is transmitted may not be used. The number and locations of those slots may be based on a predefined configuration. Slots that are not allocated for UL (e.g., in the case of Time Division Multiplexing (TDD)) or do not have all the symbols available (as per SL BWP configuration) may also be excluded from the resource pool. Some slots may be reserved such that a number of remaining slots is a multiple of a bitmap length defined by the labels sl-TimeResource-r16 or Lbitmap, that can range from 10 bits to 160 bits. The reserved slots may be spread throughout a variable number of slots. The bitmap sl-TimeResource-r16 may be applied to the remaining slots to compute a final set of identified/labeled slots that belong to the pool.

A communication device (e.g., UE) may perform a Listen Before Talk (LBT) procedure to establish a Channel Occupancy Time (COT) of different channels in the sidelink resource pool in accordance with embodiments. More specifically, a communication device may perform a Type 1 or Type 2 Clear Channel Assessment (CCA) LBT procedure before accessing a resource.

A Type 1 CCA refers to a channel access mode with multi-slot channel sensing with a random backoff based on an adjusted contention window size. A corresponding Channel Access Priority Class (CAPC) value may be established according to a priority of a service to be transmitted. The maximum COT length (MCOT) may also be established in view of the CAPC values.

The Type 2 CCA refers to a channel access mode based on a monitoring slot of a fixed length and using the channel, if clear. The Type 2 channel access mode includes Type 2A channel access, Type 2B channel access, and Type 2C channel access. The different types 2A, 2B, and 2C refer to decreasing timings (in us) of the single shot channel sensing. The specific Type 2 CCA used (A, B, or C) in embodiments may be selected based on the size of the available transmission gap, if known, with Types 2B and 2C being used for smaller gaps (e.g., less than 25 μs).

When a communication device performs a Type 1 CCA LBT procedure to establish a COT in the sidelink, the communication device may not use the entire COT. Embodiments disclosed herein provide procedures for sharing the COT with other communication devices in the sidelink. Although some limited COT sharing between a base station and UE has been established (see, e.g., TS 37.213, clause 4.2.1.0.3 and Section 4.1.3), embodiments herein advantageously provide COT sharing for unicast, groupcast, and broadcast messages between communication devices in the sidelink framework.

In embodiments herein, in general, the Type 1 channel access mode is used for a communication device to initiate channel occupancy, and a Type 2 channel access mode may be used for a communication device to share channel occupancy.

Embodiments disclosed herein provide Sidelink Control Information (SCI) signaling for support of SL COT sharing and resuming use of the COT after sharing. Embodiments further provide methods for a communication device to performing a Type 2 CCA to access a shared COT. Embodiments define appropriate Cyclic Prefix Extensions (CPEs) used by responding devices in the COT sharing processes. As explained below, in some embodiments, the COT sharing information may be treated as a reservation according to a priority associated with the transmissions of the communication devices in the sidelink.

The following is a glossary of terms that may be used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (also “User Device” or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, etc. In general, the term “UE” or “UE device” can be broadly defined to encompass any electronic, computing, and/or telecommunications device (or combination of devices) which is transportable by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “base station” or “wireless station” has the full breadth of its ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” etc., may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” etc., are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some aspects, “approximately” may mean within 0.1% of some specified or desired value, while in various other aspects, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

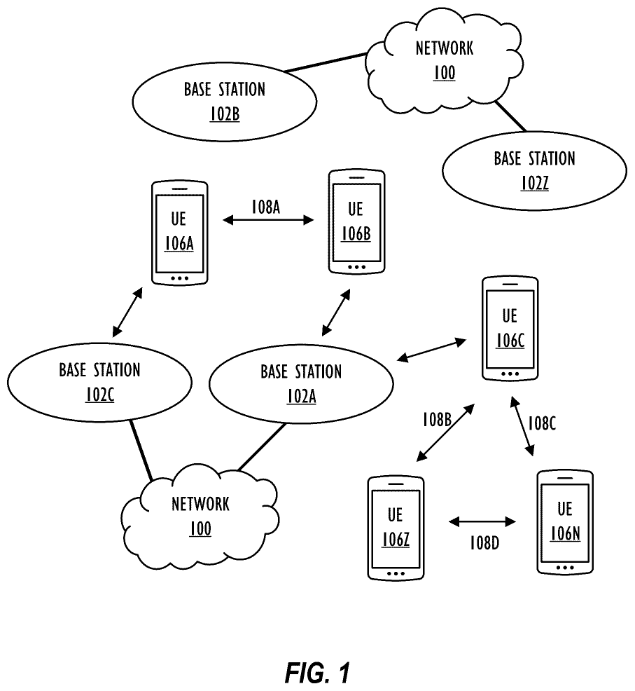

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106Z. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106Z.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a PC5 interface for direct communications between devices. The IoT UEs may also execute background applications (e.g., keep-alive messages, status updates, and the like) to facilitate the connections of the IoT network.

As shown in FIG. 1, the UEs 106, such as UE 106A and UE 106B, may directly exchange communication data via a PC5 interface 108A. Also, the UEs 106C, 106N, and 106Z, may collectively exchange communication data via a PC5 interfaces 108B, 108C, and 108D. In general, such PC5 interfaces are referred to as SL connections.

The PC5 interface 108 may comprise one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH). The PC5 interface 108 may be responsible for direct communication between devices (unicast), group messaging among select devices (groupcast), and broadcast messaging in accordance with embodiments disclosed herein.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE, eNB, or by a gNB. For example, an RSU is a computing device coupled with radio frequency circuitry located on a roadside that provides connectivity support to passing vehicle UEs.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106Z and similar devices over a geographic area via one or more cellular communication standards.

Thus, while base station 102A may act as a “serving cell” for UEs 106A-106Z as illustrated in FIG. 1, each UE 106 may also be capable of receiving signals from (and possibly within communication range of) one or more other cells (which may be provided by base stations 102B-102Z and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to some of the cellular communication protocols discussed herein. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a set of resource elements. There are several different physical downlink channels that are conveyed using such resource blocks.

One such channel is the physical downlink shared channel (PDSCH) that may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

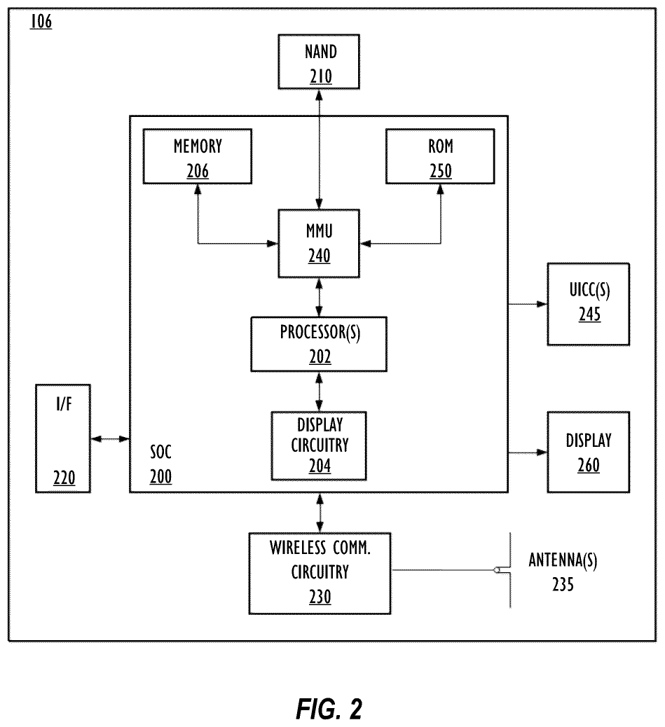

FIG. 2 illustrates user equipment 106 (e.g., one of the devices 106A through 106N) in communication with a base station 102 or other user equipment 106, according to some aspects. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some embodiments, a downlink resource grid can be used for downlink transmissions from any of the base stations 102 to the UEs 106, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher-layer signaling to the UEs 106. The physical downlink control channel (PDCCH) may carry information about the transport format and resource allocations related to the PDSCH channel, among other things. It may also inform the UEs 106 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

FIG. 2 illustrates an example simplified block diagram of a communication device 106, according to some aspects. It is noted that the block diagram of the communication device of FIG. 2 is only one example of a possible communication device. According to aspects, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; etc.), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, etc.). In some aspects, communication device 106 may include wired communication circuitry (not shown), such as a network interface card, e.g., for Ethernet.

The wireless communication circuitry 230 may couple (e.g., communicatively; directly or indirectly) to one or more antennas, such as antenna(s) 335 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some aspects, as further described below, cellular communication circuitry 230 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The user interface elements may include any of various elements, such as display 260 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 245 that include SIM (Subscriber Identity Module) functionality, such as one or more UICC(s) (Universal Integrated Circuit Card(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein, e.g., by executing program instructions stored on a memory medium (e.g., a non-transitory computer-readable memory medium). Alternatively (or in addition), processor 202 may be configured as a programmable hardware element, such as an FPGA (Field Programmable Gate Array), or as an ASIC (Application Specific Integrated Circuit). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, etc.) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, etc.) configured to perform the functions of wireless communication circuitry 230.

### Example Base Station

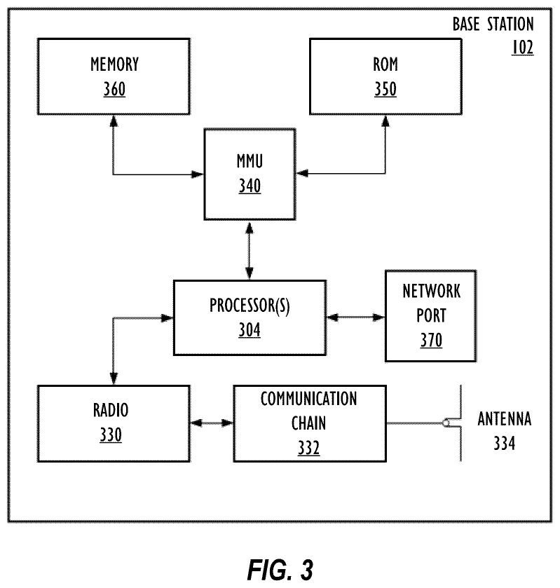

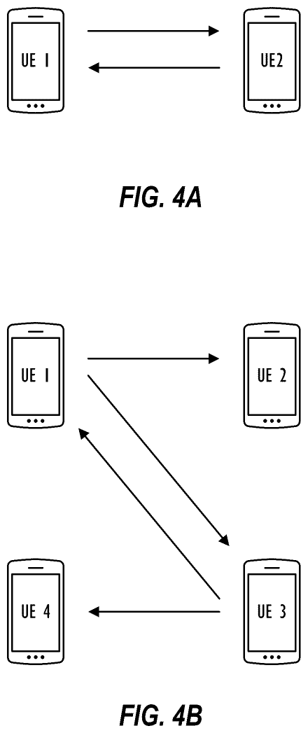

FIG. 3 illustrates an example block diagram of a base station 102, according to some aspects. It is noted that the base station of FIG. 4 is merely one example of a possible base station. As shown, the base station 102 may include processor(s) 304 which may execute program instructions for the base station 102. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 102 may include at least one network port 370. The network port 370 may be configured to couple to a telephone network and provide a plurality of devices, such as UE devices 106, access to the telephone network as described above in FIGS. 1 and 2.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB.” In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 304 of the base station 102 may be configured to implement or support implementation of part or all of the methods described herein, e.g., by executing program instructions stored on a memory medium (e.g., a non-transitory computer readable memory medium). Alternatively, the processor 304 may be configured as a programmable hardware element, such as an FPGA (Field Programmable Gate Array), or as an ASIC (Application Specific Integrated Circuit), or a combination thereof. Alternatively (or in addition) the processor 304 of the BS 102, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, etc.) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, etc.) configured to perform the functions of radio 330.

In a sidelink scenario, the wireless device is communicating directly with other wireless devices without communications having to be routed through a wireless node. Sidelinks (e.g., via the PC5 interface) are the logical direct interface between wireless devices.

Embodiments disclosed herein provide Sidelink Control Information (SCI) signaling field for support of SL COT sharing and resuming use of the COT. The SCI may be transmitted using a first-stage SCI transmission (via a PSCCH), a second-stage SCI transmission (via a PSSCH), or combinations thereof. Embodiments include time domain information as part of the COT sharing information.

FIG. 4A and FIG. 4B illustrate different sidelink communications in accordance with some aspects. FIG. 4A demonstrates a typical unicast transmission between UE 1 and UE 2. FIG. 4B demonstrates other sidelink communications, according to some aspects. For example, FIG. 4B demonstrates a groupcast transmission from UE 1 to both UE 2 and 3. As shown in FIG. 4B, UE 1 may not be in direct communication with UE 4. Also, UE 2, UE 3, and UE 4 may or may not be in communication with a base station. Such scenarios may be dependent on network conditions, locations, and the like.

In FIG. 4A and 4B, UE 1 may be considered the COT-initiating UE. In some embodiments, UE 1 may perform a Type 1 CCA and, then, initialize the COT for its own transmissions.

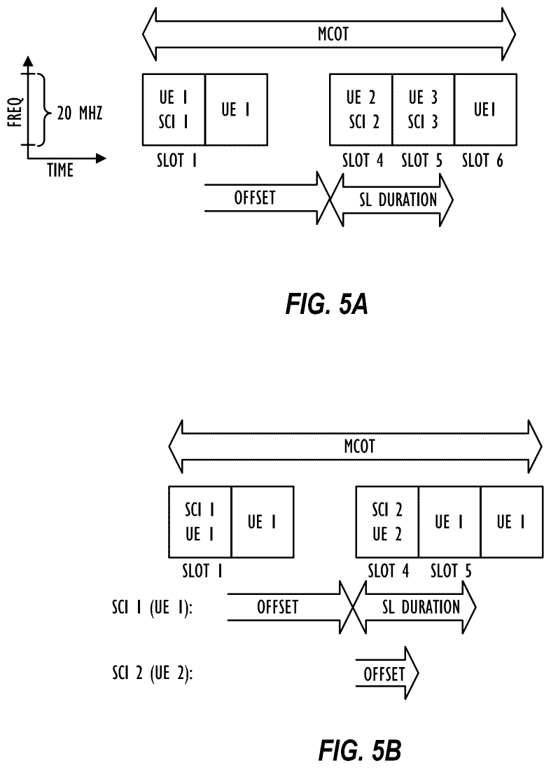

FIGS. 5A and 5B illustrate SCI signaling for sharing a COT, according to some aspects. In FIGS. 5A and 5B, the offset and SL duration for all potential SL transmissions in the shared COT are signaled. In embodiments herein, the maximum gap for transmissions may be set to 25 μs or less. The CCA bandwidth may be 20 Mhz, similar to current CCA processes.

For example, in FIG. 5A, UE 1 may transmit in Slot 1 SCI with an offset and SL duration that indicates that, after the offset, UE 1 is going to share two slots Slot 4 and Slot 5 of the COT in the SL duration. The offset and SL duration in the SCI indicate the shared resource pool for all the UEs qualified to share the COT. In these examples, the SL duration is indicated in terms of a number of slots; however, embodiments may define the SL duration in terms of the remaining slots or remaining duration of the COT.

The indication is received by the qualifying UEs, which may then preform a resource selection, such as a Type 2 CCA, to transmit using the shared COT indicated in the SL duration. The SCI may include a destination ID, such as a groupcast ID or unicast ID, that indicates the qualifying UEs. In FIG. 5A, UE1 transmits in both slot 1 and slot 2 with different transmission blocks. In one alternative, the SCI information on offset and duration is sent in slot 1 only. In another alternatives, the SCI information on offset and duration is sent in both slot 1 and slot 2. Offset value in slot 2 is modified appropriately.

In an example of FIG. 5A, UE 2 transmits in the Slot 4, and UE 3 transmits in Slot 5. UE 2 and UE 3 may also transmit SCI 2 and SCI 3, respectively. In this scenario, there is some potential for collisions between UE 2 and UE 3 accessing the slots. In some embodiments, a priority may be established for potential transmissions within the shared slots of the COT. The priority may be based on CAPC value associated with the transmissions.

Further, embodiments have the ability for the initiating UE to resume transmissions in the COT, after sharing. As shown in FIG. 5A, UE 1 may resume transmission in Slot 6, after the SL duration concludes.

In FIG. 5A, UE 1 may have no knowledge regarding any desired transmissions from UE 2 or UE 3. In previous UL/DL COT sharing methods using a base station, the base station has the advantage of knowing a UE's need to transmit, via Buffer Status Reports (BSR) and the like. Accordingly, embodiments disclosed herein are distinguishable in that the device sharing the COT may have no knowledge of pending transmissions from other devices.

As noted above, the COT may be shared with qualifying UEs. In embodiments herein, a qualifying UE may be a receiving UE, which is the target of a PSCCH/PSSCH transmission of a COT initiator. For example, the qualifying UEs may include some or all of the UEs associated with the resource pool. The SCI transmitted by the sharing UE includes a destination ID. The destination ID may include a groupcast ID, unicast ID, or other ID to identify the qualifying UEs that may share the COT.

In the case of a unicast transmission from the COT initiator, the source and destination IDs contained in the COT initiator's SCI will match to corresponding destination and source IDs relating to the same unicast at the receiving UE. In the case of a groupcast and/or broadcast, the destination ID contained in the COT initiator's SCI will match to a destination ID known at the receiving UE. For example, a preconfigured group configuration (groupcast ID) known to the receiving UE is used.

A responding UE may also be a UE identified by other ID(s), if additional IDs are supported in the COT sharing information. Such additional IDs may be in addition to the source and destination IDs of the PSCCH/PSSCH transmission, when additional IDs are included in the COT sharing information from the COT initiator.

In accordance with embodiments disclosed herein, the UE that initiates the COT may desire to transmit prior to the end of the SL duration. For example, if a desired transmission for UE 1 manifests during the COT, after the SCI information has indicated sharing a portion of the COT.

In some embodiments, the COT initiating UE may be forbidden from transmitting during the indicated SL duration. For example, referring to FIG. 5A, UE 1 may be forbidden by policy from transmitting in Slot 4 and Slot 5.

In other embodiments, the UE that initiates the COT may be allowed to transmit during an indicated SL duration or offset. For example, with reference to FIG. 5A, UE 1 may participate in a similar resource selection as UE 2 and UE 3 for use of the shared portions of the COT, e.g., a Type 2 CCA. As a result, UE 1 may transmit in the shared portion of the COT in slot 1, as demonstrated in FIG. 5B. Specifically, in FIG. 5B, UE 1 transmits in Slot 5, during the SL duration.

In accordance with embodiments disclosed herein, the UE's desire to transmit in contrast to its previously indicated sharing may be based on priority of the desired transmission. The priority may be based on CAPC value associated with the desired transmission. For example, if initiating UE manifests traffic with a specified CAPC value (or lower) after the COT is initiated, the initiating UE may attempt to transmit prior to the end of the SL duration. In accordance with known standards, the CAPC value may indicate different categories of transmissions corresponding to different priorities, where the lower the CAPC value, the higher the priority of the transmission.

In embodiments herein, a responding UE may indicate an expected duration of its transmission. A responding UE may transmit SCI that indicates the UE is finished with the shared portion of the COT. In some embodiments, the SCI includes an expected duration of the transmission. As will be explain in more detail below, an expected duration of the transmission may be transmitted as an offset in the SCI.

For example, referring to FIG. 5B, SCI 2 transmitted in Slot 4 may include an indication that UE 2 is releasing the shared portion of the COT. As a specific example, UE 2 may transmit SCI 2 with an offset that is the expected duration of the UE 2 transmission in the shared portion of the COT. In such embodiments, UE 1 may resume transmissions after UE 2 is finished, in Slot 5.

As described above, a policy may be instituted such that an initiating UE is not allowed to resume transmissions prior to expiration of the SL duration. However, even in such embodiments, an initiating UE may be allowed to resume transmissions in the COT based on SCI received from one or more responding UEs. For example, referring to FIG. 5B, the SCI 2 from UE 2 in Slot 2 may include information that indicates UE 1 may resume transmissions in Slot 5 of the COT.

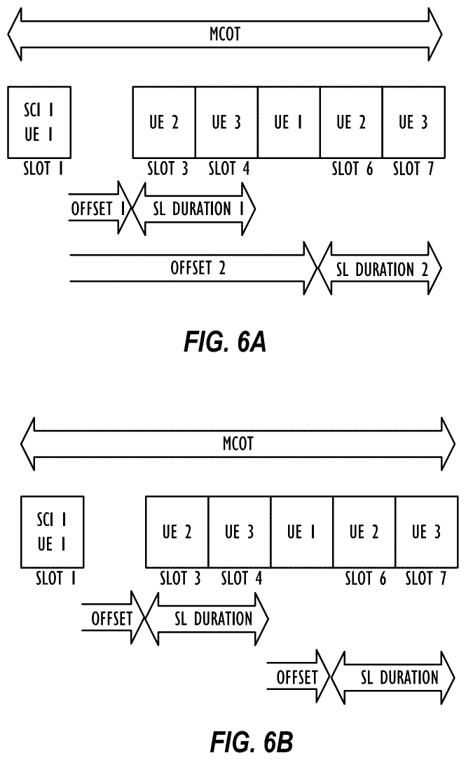

FIGS. 6A and 6B illustrate SCI signaling for sharing portions of a COT, according to some aspects. In these embodiments, the initiating UE may indicate multiple distinct portions of the MCOT that are available for sharing. These embodiments may apply if the initiating UE knows, or anticipates, that it will have another transmission for the COT, but is able to share a portion of the COT before such a transmission. In such embodiments, the initiating UE may include one or more sets of offset/SL duration pairs defining different portions of MCOT to be shared.

For example, in FIG. 6A, SCI 1 transmitted in Slot 1 may include two sets of offset/SL duration pairs, the first set indicating a one slot offset 1 and a two slot SL duration 1. The second set indicates a four slot offset 2 and a two slot SL duration 2. As shown, UE 2 may transmit in Slot 3 and Slot 6, and UE 3 may transmit in Slot 4 and Slot 7. UE 1 is free to transmit in Slot 5 of the COT because this slot was part of the offset 2.

In the examples of FIG. 6B, a repeating set of an offset and SL duration is used. More specifically, a single slot offset and two slot duration is transmitted in Slot 1, and the pattern is repeated across the MCOT. As such, UE 1 is free to transmit in Slot 5 of the MCOT because this slot occurs during the single slot offset. Although embodiments of FIG. 6A and 6B may achieve similar results as shown, embodiments of FIG. 6B may require less overhead in transmitting the SCI 1.

In embodiments disclosed herein, qualifying UEs that use the shared portion of the COT are forbidden from further sharing in the same COT. That is, when one UE shares a COT, another UE may not further share parts of the same COT.

For example, referring to FIG. 4B, if UE 1 initiates a COT and indicates sharing a portion of the COT to UE 2 and UE 3. The SCI of UE 3 to UE 4 will indicate that the COT may not further be shared by using a default value. The same is true for the SCI of UE 2 to UE 1 in FIG. 4A. Such a default value may also be used by UE 1 to indicate in the SCI that there will be no sharing of the COT.

Accordingly, in embodiments disclosed herein, the values corresponding to the offset and SL duration included in a responding UE's SCI are established. In some embodiments, the offset and duration may be set a default value, for example zero, to indicate the COT may not be shared.

In some embodiments, the SL duration may be set to zero, and the offset may be set to an expected duration of the transmission by the responding UE. As mentioned with respect to FIG. 5B, the responding UE 2's SCI 2 may indicate an expected end of the transmission or a releasing of the COT from UE 2. As UE 2 is unable to further share the COT, this indication may be included as an offset in SCI 2. In some embodiments, UE 1 may treat the received value as an offset for resuming a transmission.

In some embodiments, the offset and sidelink duration for each SL transmission in the shared COT may be signaled to an appropriate UE. Such embodiments may be considered analogous to current DL scheduling with a base station. In such embodiments, the SCI may include an indication of the Type of CCA and a Cyclic Prefix Extension (CPE) to be used by the responding UE to access the shared portion. In embodiments herein, a Type 2 CCA process is used for qualifying UEs to access the shared portion of the COT.

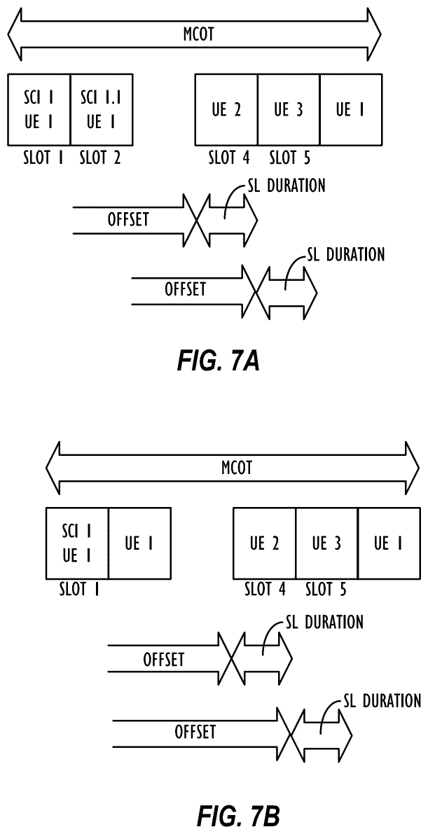

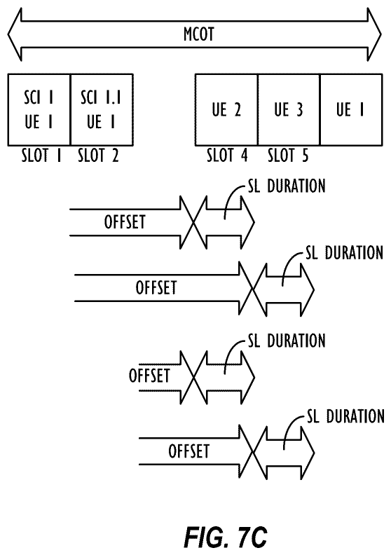

FIGS. 7A, 7B, and 7C illustrate different SCI signaling scenarios for sharing a COT, according to some aspects. FIGS. 7A, 7B, and 7C demonstrate different alternatives for directly signaling an offset and SL duration to a specific UE, according to some aspects.

In FIG. 7A, the SCI 1 of UE 1 transmitted in Slot 1 has a destination ID of UE 2 and an offset and SL duration that indicates that UE 2 may transmit in Slot 4. The SCI 1.1 from UE 1 transmitted in Slot 2 has a destination ID of UE 3 and an offset and SL duration that indicates that UE 3 may transmit in Slot 5. Thus, an offset and SL duration for a specific responding UE is included in SCI. Embodiments associated with FIG. 7A function adequately when directed to unicast traffic.

FIG. 7B demonstrates an alternative SCI signaling method, according to some aspects. In FIG. 7B, the SCI includes multiple sets of offset and SL durations directed to responding UEs. The SCI may be transmitted in the first slot after initiating the COT. Specifically, the SCI 1 from UE 1 in Slot 1 includes an offset and SL duration for UE 2 to transmit in Slot 4 and an offset and SL duration for UE 3 to transmit in Slot 5. The sets of offsets and SL durations direct UE 2 and UE 3 to share the COT at Slot 4 and Slot 5, respectively. Although embodiments of FIG. 7B require more overhead than those demonstrated in FIG. 7A, embodiments of FIG. 7B may allow UE 2 and UE 3 more processing time to use the shared COT.

FIG. 7C demonstrates another alternative SCI signaling method, according to some aspects. In FIG. 7C, every SCI transmitted includes multiple sets of offset and SL durations directed to responding UEs. Specifically, SCI 1 from UE 1 that is transmitted in Slot 1 includes: a first offset and SL duration directed to UE 2 indicating that UE 2 may share Slot 4 of the COT, and a second offset and SL duration directed to UE 3 indicating that UE 3 may share Slot 5 of the COT. The SCI 1.1 that is transmitted from UE 1 in Slot 2 also includes offset and SL duration pairs for UE 2 and UE 3 indicating that Slot 4 and Slot 5 are available for sharing. The offset values decrease in SCI 1.1 compared to the offset values given in SCI 1. Although embodiments of FIG. 7C may be more stable, with less chance of qualifying UEs missing a shared portion of a COT, these embodiments require significant overhead for transmitting the SCI.

Embodiments disclosed herein also include combinations of the aspects demonstrated in FIGS. 5 to 7. For example, for SCIs directed to unicast transmissions, embodiments associated with FIG. 7 may be used. For SCIs directed to groups of UEs, embodiments associated with FIGS. 5 and/or 6 may be used.

As previously noted, the SCI of the initiating UE may include an indication of the specific Type 2 CCA process to be used and also may include a CPE to be used by the responding UE.

In embodiments where the shared SL resources are indicated to all the qualifying UEs, e.g., those in FIG. 5, the responding UEs will perform a Type 2 CCA resource (re-)selection procedure. The transmission on the shared resource starts from the offset and within the SL duration time.

Under some conditions, there may be existing reservations by other UEs with the COT. Such UEs may not be qualifying UEs. That is, these UEs may not be included in the destination ID of the SCI of the initiating UE. These existing reservations may include periodic transmissions, HARQ transmissions, etc. The existing reservations are possible in view of the standard reservation procedures that may be employed by the UE's in the network. A priority, such as a CAPC value or L1 priority, may be associated with such transmissions.

Therefore, in some embodiments, the shared slots/RB sets within the COT may have an existing reservation by other UEs with higher priority, when the other UEs are not part of qualifying COT sharing UEs.

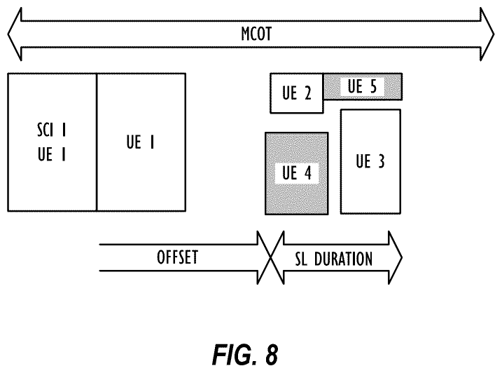

FIG. 8 illustrates sharing portions of a COT with non-responding communication devices, according to some aspects. FIG. 8 refers to UE 4 and UE 5 that are not part of the destination ID of the SCI of the initiating UE of the COT. However, UE 4 and UE 5 may have an existing reservation shown as the shaded region. Further, as illustrated, the existing reservation may not include take up the full 20 MHz bandwidth of a slot.

For FIG. 8, consider that UE 1 shared an offset and SL duration in SCI 1 to UE 2 and UE 3, similar to the previous examples of FIGS. 5-6. In embodiments herein, UE 2 and UE 3 may track if there is already some existing reservation within the COT with a higher priority within the duration. Therefore, UE 2 and UE 3 track the reservations of UE 4 and UE 5 shown as the shaded regions in FIG. 8. In embodiments disclosed herein, if the priority of the transmissions of UE 4 and UE 5 is higher, the CPE of UE 2 and UE 3 may be engineered to facilitate the appropriate transmissions.

For example, in one alternative, the CPE may be designed such that the reserved transmission with the higher priority starts earlier. Specifically, the UEs sharing the COT (e.g., UE 2 and UE 3) may transmit the transmission with a CPE=0. Thus, the CPE from UE 4 would start earlier (by at least 16 μs). This gives a higher priority to UE 4 and UE 5, because UE 2 and UE 3 would fail a Type 2 CCA needed to transmit in the shared slot. Thus, the transmissions of UE 2 and UE 3 will not block the higher priority, reserved transmissions of UE 4 and UE 5.

In another alternative, default CPEs may be used, regardless of the priority associated with the transmissions of qualifying UEs that can share the COT. Using the previous example, UE 2 and UE 3 may transmit and perform the CCA with a pre-configured, or default, CPEs. In this alternative, the default CPEs may be used, regardless of the priority. This alternative may enable transmissions at the same time without mutually blocking each other, but there is a chance that collisions may occur within the slot.

In another alternative, a random CPE selected from possible CPE starting positions within 1 or 2 OFDM symbols may be used. In this alternative, using the previous example, UE 2 and UE 3 may transmit and perform the CCA with the randomly selected CPE from the possible CPEs within the first couple of OFDM symbols. In this alternative, the larger CPE of the reserved transmissions would start earlier and block transmissions from the other UEs. Accordingly, there would be no collisions in this alternative because the other UEs are blocked during the CCP/CPE accessing process.

If there are no shared slots/RB sets with existing reservations by other UEs with a higher priority, the resource selection of the responding UEs may depend on the bandwidth of the desired transmission in the shared slot. For example, referring to FIG. 8, if there is no reservation (or higher priority reservation) for UE 4 and UE 5, a qualifying UE (UE 2 or UE 3) may determine a access procedure based on the bandwidth of the desired transmission to be performed in the shared portion of the COT.

If a responding UE desires a full (20 MHz) bandwidth transmission, the responding UE may choose a random starting position configured within 1 or 2 OFDM symbols. This may reduce the chances of a collision in the shared resource. If the responding UE desires a partial bandwidth transmission, such as those shown for UE 2 and UE 3 in FIG. 8, the responding UE may choose a pre-configured starting position, as in previous examples above.

In some embodiments, a responding UE may use a pre-configured CPE or randomly selected CPE, as described in the alternatives above, regardless of the desired bandwidth of the transmission.

In embodiments where the shared SL resources are indicated to each responding UE, such as those in FIG. 7, if there is a reservation with higher priority, the UE may simply stop the transmission. In some embodiments, the responding UE may attempt to transmit according to the scheduling after Type 2 CCA, regardless of another UE's reservation or priority.

In some embodiments, the COT sharing information may be treated as a reservation by UEs that are not included in the destination ID of the SCI. That is, UEs that are non-responding UEs, upon receiving SCI that carries COT sharing information that includes the MCOT length, the non-responding UEs may treat the COT sharing information from the SCI as a reservation for the MCOT, and the UEs perform a resource reselection process for transmissions.

Such a reservations may depend on relative priorities between the transmissions of the responding UEs and the non-responding UEs. As mentioned previously, if a CAPC value of a responding UEs desired transmission is lower (i.e., has a higher priority) than a CAPC of a non-responding UE, the non-responding UE treats the MCOT as being reserved based on the CAPC value. Alternatively, the priority may be based on an L1 priority. That is, if the L1-priority of a non-responding UE's potential transmission is lower than the L1-priority of a responding UE, the non-responding UE treats the MCOT as being reserved for the responding UEs.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method, e.g., any of a method aspects described herein, or, any combination of the method aspects described herein, or, any subset of any of the method aspects described herein, or, any combination of such subsets.

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method for sharing a Channel Occupancy Time (COT) in a sidelink (SL) channel, the method comprising:
performing a Clear Channel Assessment (CCA) by a first wireless device to initialize the COT;
determining, by the first wireless device, that a portion of the COT may be shared;
transmitting, by the first wireless device to one or more qualifying wireless devices, first Sidelink Control Information (SCI), the first SCI comprising: a destination identification (ID), an offset, and a SL duration, wherein the destination ID indicates one or more qualifying wireless devices, and wherein the SL duration defines a duration of time available for the one or more qualifying wireless devices to share the COT.

2. The method of claim 1, wherein the SL duration indicates the remaining duration of the COT.

3. The method of claim 1, further comprising:
resuming transmission in the COT, by the first wireless device, after the SL duration.

4. The method of claim 1, further comprising:
resuming transmission in the COT, by the first wireless device, prior to the end of the SL duration.

5. The method of claim 4, further comprising:
receiving, by the first wireless device, second SCI from one of the one or more qualifying devices indicating a conclusion of transmissions in a shared portion of the COT.

6. The method of claim 5, wherein an expected value of the duration of the second wireless device transmission is indicated as an offset in the second SCI.

7. The method of claim 4, further comprising:
performing a second CCA, by the first wireless device, prior to resuming transmission.

8. The method of claim 4, wherein the resumed transmission has a Channel Access Priority Class (CAPC) value indicating a higher priority than potential transmissions from the one or more qualifying wireless devices.

9. The method of claim 1, the first SCI further comprising: a second offset and a second SL duration, wherein the second offset and second SL duration define a second duration of time available for the one or more qualifying wireless devices to share the COT.

10. The method of claim 1, wherein the offset and SL duration are repeated at regular intervals across the COT.

11. The method of claim 10, wherein the destination ID indicates a second wireless device.

12. The method of claim 1, the first SCI further comprising: a second offset and a second SL duration, wherein the offset and SL duration indicate a first slot available for sharing, and the second offset and second SL duration indicate a second slot available for sharing.

13. The method of claim 12, wherein the offset and SL duration are associated with a first qualifying wireless device of the one or more qualifying wireless devices, and the second offset and second SL duration are associated with a second qualifying wireless device of the one or more qualifying wireless devices.

14. The method of claim 1, further comprising:
transmitting, by a second wireless device, second SCI comprising default values, the default values indicating that the second wireless device is not sharing the COT.

15. The method of claim 13, wherein the default values comprise a zero offset and zero SL duration.

16. The method of claim 11, wherein the default values comprise an offset value indicating an expected duration of a transmission from the second wireless device.

17. A wireless device comprising:
an antenna;
a radio operably coupled to the antenna; and
a processor operably coupled to the radio, wherein the wireless device is configured to:
perform a Clear Channel Assessment (CCA) by a first wireless device to initialize a Channel Occupancy Time (COT);
determine that a portion of the COT may be shared;
transmit to one or more qualifying wireless devices, first Sidelink Control Information (SCI), the first SCI comprising: a destination identification (ID), an offset, and a SL duration,
wherein the destination ID indicates one or more qualifying wireless devices, and wherein the SL duration defines a duration of time available for the one or more qualifying wireless devices to share the COT.

18. The wireless device of claim 17, wherein the SL duration indicates the remaining duration of the COT.

19. The wireless device of claim 17, wherein the wireless device is further configured to:
perform a second CCA to transmit in the COT prior to the end of the SL duration.

20. A baseband processor configured to cause a wireless device to:
perform a Clear Channel Assessment (CCA) by a first wireless device to initialize a Channel Occupancy Time (COT);
determine that a portion of the COT may be shared;
transmit to one or more qualifying wireless devices, first Sidelink Control Information (SCI), the first SCI comprising: a destination identification (ID), an offset, and a SL duration, wherein the destination ID indicates one or more qualifying wireless devices, and
wherein the SL duration defines a duration of time available for the one or more qualifying wireless devices to share the COT.
